(19) United States
(12) Patent Application Publication
(10) Pub. No.: US 2018/0285429 A1
(43) Pub. Date: Oct. 4, 2018

(54) GRAPHICAL RESPONSE GROUPING

(71) Applicant: Hewlett-Packard Development Company, L.P., Houston, TX (US)

(72) Inventors: Yang Lei, Palo Alto, CA (US); James Vanides, Palo Alto, CA (US); Jerry Liu, Palo Alto, CA (US)

(21) Appl. No.: 15/764,549

(22) PCT Filed: Dec. 11, 2015
(86) PCT No.: PCT/US2015/065338

§ 371 Date: Mar. 29, 2018

(51) Int. Cl. G06F 17/30; G09B 7/02

(52) U.S. Cl. CPC G06F 17/30554; G09B 7/02; G06F 17/30867; G06F 17/30601

(57) ABSTRACT

Examples associated with graphical response grouping are described. One example includes providing a query to a set of client devices. The query may request a graphical response from respective users of members of the set of client devices. A graphical response is received from the respective users via the client devices. The graphical responses are classified into groups based on graphical attributes of the graphical responses. Representative responses from the groups are provided to a supervisor.

### BACKGROUND

In a classroom setting, student response systems are used to get real time information about how well students are learning new material. Some systems operate by asking students questions, often true/false or multiple choice questions, and receiving responses from students using an electronic “clicker”. The answers can then be used by an instructor to, for example, evaluate whether certain topics should be revisited or clarified due to confusion if responses from the students are varied or incorrect.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example devices and modules associated with graphical response grouping.

FIG. 2 illustrates a flowchart of example operations associated with graphical response grouping.

FIG. 3 illustrates another flowchart of example operations associated with graphical response grouping

FIG. 4 illustrates an example system associated with graphical response grouping.

FIG. 5 illustrates another example system associated with graphical response grouping.

FIG. 6 illustrates another example system associated with graphical response grouping.

FIG. 7 illustrates an example computer in which example systems, and methods, and equivalents, may operate.

### DETAILED DESCRIPTION

Systems, methods, and equivalents associated with graphical response grouping are described. In various examples a teacher or other leader may provide a query to students or group members that solicits an illustrated response. For example, a math teacher may ask students to sketch a relationship or equation. After distributing the query to devices operated by the students and receiving graphical responses to the query, the responses may be classified into a set of groups.

This grouping may be performed using clustering techniques that function after the graphical responses are converted into a set of feature vectors. Once grouped, representative responses from the groups may be provided to the teacher, and the teacher may use the representative responses, to, for example, evaluate whether further instruction on a topic is desirable, lead a discussion on a topic, and so forth. This may include, for example, publically sharing some of the responses via, for example, the student devices, a public display, and so forth.

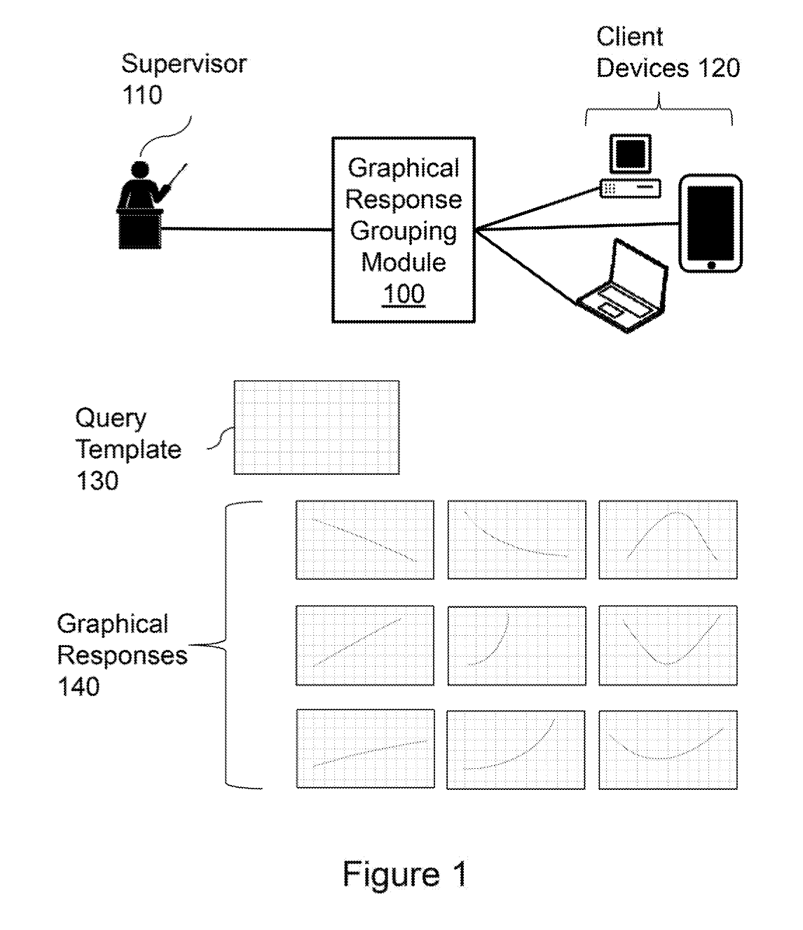

FIG. 1 illustrates an example devices and modules associated with graphical response grouping. It should be appreciated that the items depicted in FIG. 1 are illustrative examples and many different devices, modules, and so forth may operate in accordance with various examples.

FIG. 1 illustrates an example graphical response grouping module 100. In this example, graphical response grouping module 100 may act as an intermediary between a supervisor 110 and a set of client devices 120. In this example, supervisor 110 may be a teacher or leader interacting with students or participants that are operating client devices 120. In various examples, supervisor 110 may interacting with graphical response grouping module 100 via a desktop computer, though supervisor 110 may interact with other types of devices (e.g., laptop computer, tablet). Client devices 120 may also be numerous types of devices including laptops, desktops, tablets, and so forth. In some examples, supervisor 110 and client devices 120 may all be operating in a single location (e.g. a classroom or lecture hall). This may be appropriate when supervisor 110 is presenting in person to users of client devices 120 (e.g., students). In other examples, supervisor 110 may electronically present to users of client devices 120 who are “attending” the presentation from other locations (e.g., their homes).

In various examples, graphical response grouping module 100 may reside in numerous locations. Where it resides may depend on how supervisor 110 and client devices are intended to interact, their relative locations, and so forth. Thus, in some examples, graphical response grouping module may reside, for example, in a device operated by supervisor 110, on a separate device (e.g., a server), on a combination of a device operated by supervisor 110 and a separate device, and so forth.

At various points during a presentation, the supervisor 110 may desire to determine whether users of client devices 120 are understanding and/or retaining the material presented during this presentations, or from previous presentations. Other applications, such as preview questions that present a concept to be covered, or instigating a discussion, may also be appropriate. Though some systems may facilitate collecting multiple choice responses (e.g., true/false), collecting more complex responses (e.g., unstructured text responses, graphical responses) may have been unfeasible. This may be due to challenges relating to collecting, organizing, and/or presenting responses once a certain number of responses have been received.

By way of illustration, previously, to collect graphical responses to a question, it may have been necessary to pass out and/or collect paper to each individual person responding to a question. The questions would then need to be collected and organized into groups. While feasible in a small classroom setting, applying this technique to larger numbers of students, such as in a lecture hall, quickly becomes burdensome and time consuming. Further, if students are not in any single location, such as students participating in a massively open online course, hand collection of graphical responses may be impossible in a manner that allows instantaneous feedback to a lecturer and/or the students.

Consequently, graphical response grouping module 100 may also organize graphical responses 140 received from client devices 120. Though many techniques may be performed to facilitate this grouping, one example technique involves converting graphical responses into feature vectors and then performing clustering techniques on the feature vectors. This may organize graphical responses 140 into a number of groups based on similarities between responses. In this example, vertical columns illustrate one possible grouping of graphical responses 140. The first column includes essentially linear responses, the second grouping illustrates exponential graphical responses, and the third grouping includes parabolic graphical responses. From the groupings, representative graphical responses may be provided via graphical response grouping module 100 to supervisor 110 at which point the representative responses can be analyzed by supervisor 110. This may allow supervisor 110 to evaluate how well users of client devices 120 are learning material, to lead a discussion regarding the responses, and so forth.

In various examples, the representative responses may be provided to supervisor 110 via a device operated by supervisor 110. This may facilitate real time analysis and interaction based on the graphical responses 140. In other examples, results may be provided to supervisor 110 via an asynchronous communication technology (e.g., email).

Other groupings of graphical responses 140 may also be possible. For example, outlier responses (e.g., indicating creative thinking, indicating clear misunderstanding) may also be provided to supervisor 110. By way of illustration, the top row of responses may illustrate examples of outliers because, despite falling into one of the categories listed above (e.g., linear, exponential, parabolic), the graphical responses 140 in the top row have different shapes than other responses sharing their categories.

As discussed above, converting graphical responses into feature vectors and performing clustering on these feature vectors may be one process for grouping graphical responses 140. However, before converting responses to feature vectors, it may be desirable to perform certain preprocessing steps on graphical responses 140. These preprocessing steps may facilitate enhanced conversion of graphical responses 140 into feature vectors by, for example, removing noise or other non-essential information, and so forth.

By way of illustration, if the query provided by supervisor 110 includes a query template 130 onto which graphical responses 140 will be drawn by users of client devices 120, it may be desirable to subtract query template 130 from responses provided by users. Other preprocessing steps may include, for example, image binarization, connected component analysis, optical character recognition, and so forth.

Once preprocessing has been completed, sets of features may be defined to represent graphical responses 140. Different features may be selected depending on the topic being discussed by supervisor 110. Consequently, features may include, for example, distribution if image edge directions at edge pixels (to determine curvature, shape, and/or orientation of graphical responses 140), relative location with respect to a template, drawing size, and so forth.

Once feature vectors have been created for graphical responses 140, one of several clustering techniques may be applied. These techniques may include, for example, K-means, expectation-maximization, and so forth. Additionally, select features may be weighted to emphasize grouping graphical responses 140 that share that feature. After clustering, graphical responses 140 should be grouped based on how near feature vectors of graphical responses 140 are to one another. From these groups, a “center” of the groups may be selected based on the feature vectors, and a representative graphical response 140 may be selected from each group that is nearest the center of that group.

By way of illustration, consider the graphical responses 140 shown. A first feature may be selected based on edge pixel orientations. For example, histograms of edge pixel orientations may be generated for each graphical response 140 where the y-axes represents the number of edge pixels whose orientation falls on corresponding degrees on the x-axes of the histograms. The histograms may then be fit using a Gaussian mixture model having two Gaussian distributions to account for the fact that parabolic graphical responses may result in bi-modal histograms. A distance between means of the two Gaussian distributions may then serve as a first feature in the feature vector. A second feature may be generated based on standard deviations of a single Gaussian distribution fit to the entire histogram of each graphical response. This gives a two dimensional feature vector, though others may be chosen depending on the circumstances. For example, other features may be based on, for example, sizes of graphical responses, positions compared to an absolute location on a template, and so forth. Clustering may then be performed on the feature vectors to generate groupings of graphical responses, and representative graphical responses from these groups may be provided to a supervisor to, for example, facilitate discussion, evaluate learning levels, and so forth. In examples where outliers are also provided, a feature vector that exceeds a threshold distance from cluster centers may be treated as an outlier. In other examples, dusters that are formed having a single feature vector or a small number of feature vectors relative to other feature vectors may have graphical responses associated with those feature vectors treated as outliers.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

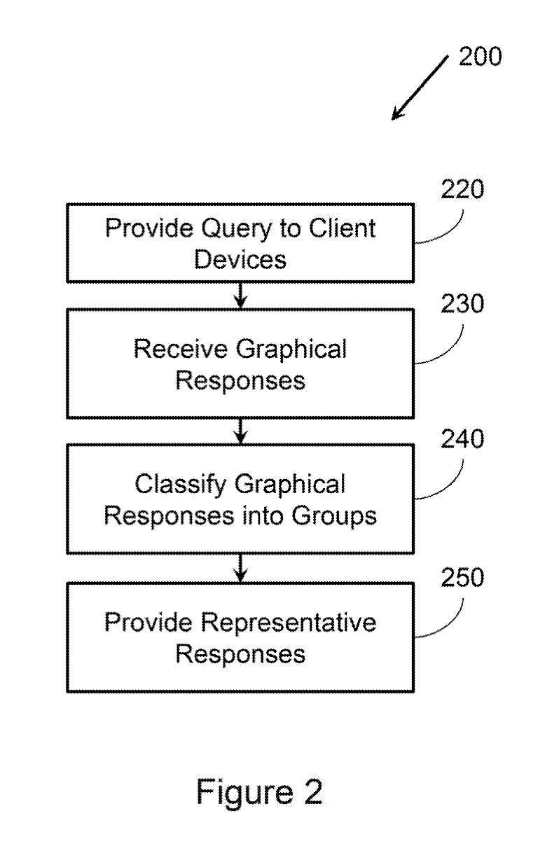

FIG. 2 illustrates an example method 200 associated with graphical response grouping. Method 200 may be embodied on a non-transitory computer-readable medium storing processor-executable instructions. The instructions, when executed by a processor, may cause the processor to perform method 200. In other examples, method 200 may exist within logic gates and/or RAM of an application specific integrated circuit.

Method 200 includes providing a query to a set of client devices at 220. The client devices may be, for example, laptops, desktops, tablets, and so forth. The query may request a graphical response from respective users of members of the set of client devices. The user may be, for example, a student attending a lecture. As used herein, a graphical response is a response that is drawn or otherwise constructed by a user. Though graphical responses may incorporate text, the derived meaning of graphical responses may be primarily determined based on pictographic and spatial relationships of lines, shapes, and so forth, which make up the graphical response.

Method 200 also includes receiving graphical responses at 230. The graphical responses may be received from the respective users via the client devices. In various examples, the query may be provided to the client devices and graphical responses may be received from the client devices by a centralized device or module responsible for organizing graphical queries and responses. The centralized device may be, or the module may reside within, a device operated by a supervisor of the students, a centralized server, a combination of the above, and so forth.

Method 200 also includes classifying the graphical responses into groups at 240. The graphical responses may be classified based on graphical attributes of the graphical responses. Classifying the graphical responses may include representing the graphical responses as feature vectors. Different attributes of graphical responses may correspond to different features of the feature vectors. For example, a first feature may relate to size of graphical responses, a second feature may relate to distance of an aspect of a graphical response to a known template location, and so forth. The graphical responses may then be clustered according to their respective feature vectors. In some examples, an attribute of a graphical response may be emphasized when clustering the graphical responses by assigning greater weight to a dimension of feature vectors associated with that attribute. By way of illustration, shapes of graphical responses may be emphasized so that, despite having different sizes, graphical responses having similar shapes (e.g., rectangular, triangular, circular) are organized into the same group.

Method 200 also includes providing representative responses from the groups to a supervisor at 250. In the example where graphical responses are clustered according to feature vectors generated from the graphical responses, a representative response from a group may be selected based on which feature vector is closest to a center of a cluster of feature vectors associated with that group.

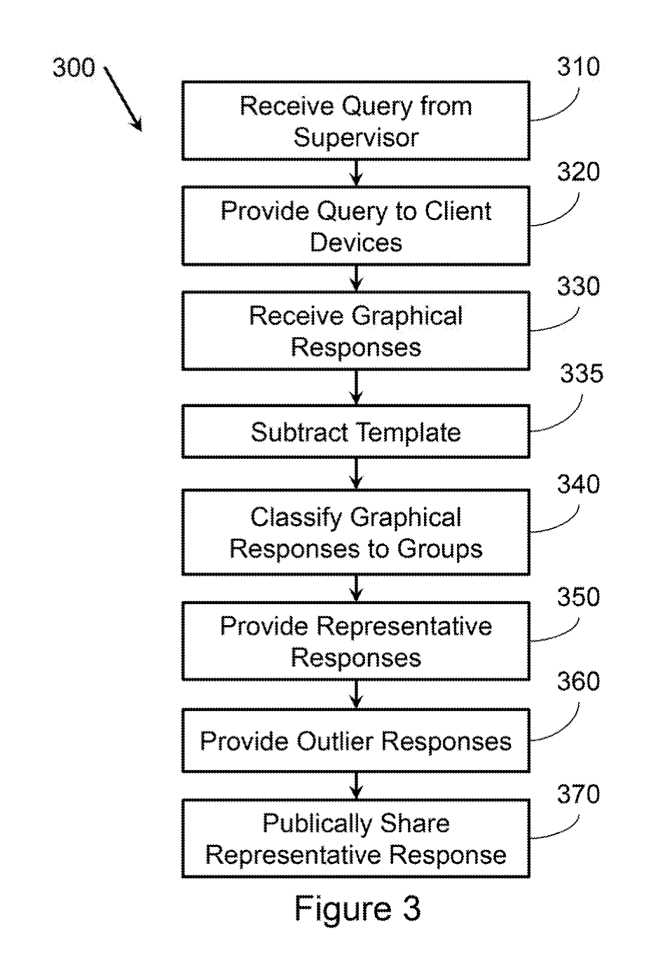

FIG. 3 illustrates a method 300 associated with graphical response grouping. Method 300 includes several actions similar to those described above with reference to method 300 (FIG. 2). For example, method 300 includes providing a query to client devices at 320, receiving graphical responses to the query at 330. Classifying graphical responses into groups at 340, and providing representative responses to a supervisor at 350.

Method 300 also includes, at 310, receiving the query to be provided to client devices at action 320. The query may be received from the supervisor. Thus, the supervisor may initiate method 300 by controlling provision of the query to the client devices. This may be desirable so that the supervisor can send out query responses at specific important moments, modify the query prior to sending the query, and so forth.

In some examples, the query may include a template. In these examples, the graphical responses may be provided on top of the template. Consequently it may be desirable, when classifying graphical responses into groups, to ignore this template information, as it may be common to all graphical responses, and could potentially distort clustering. Therefore, at 335, it may be desirable to subtract this template information from graphical responses. In one example, the template provided by the query may be provided in a color different from a color that will be used to generate graphical responses. This may make it easy to distinguish portions of graphical responses that are from the template, and portions that were added by a user.

Method 300 also includes providing outlier responses at 360. The outlier responses may be provided to the supervisor. Outlier responses may indicate, for example, creative thinking, a clear misunderstanding of an important concept, and so forth. Consequently, it may be desirable for the supervisor to be made aware of some graphical responses that are least like other graphical responses.

Method 300 also includes publically sharing a representative response at 370. The representative response may be publically shared in response to an instruction from the supervisor. In one example, the representative response may be shared via a public display (e.g., a projector). In other examples, the representative response may be transmitted to client devices, which may be efficient when client devices are spread amongst numerous separate locations.

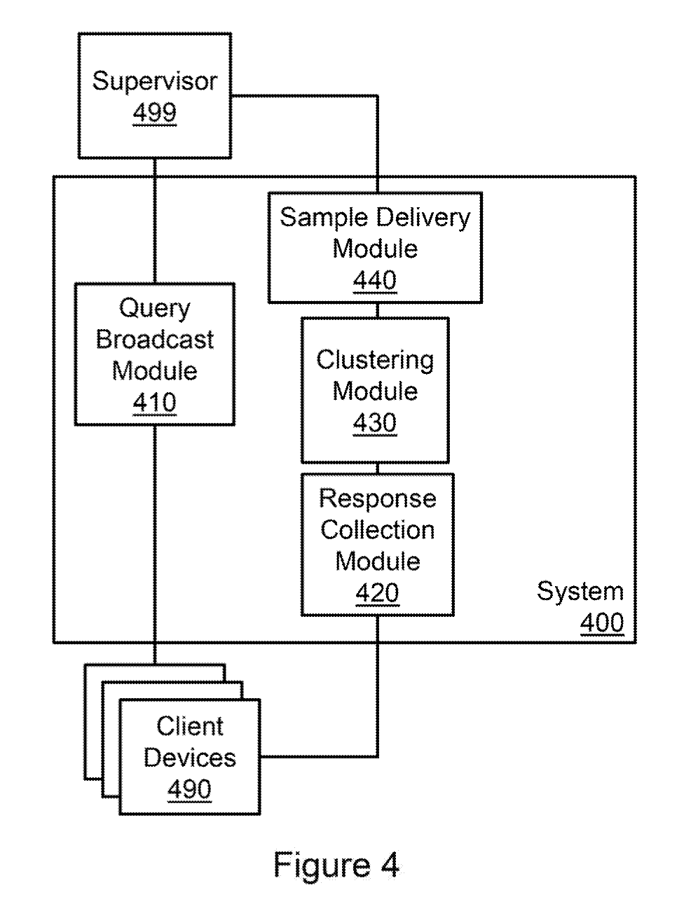

FIG. 4 illustrates a system 400 associated with graphical response grouping. In various examples, system 400 may operate at a unique location (e.g., a server), within another device shown (e.g., supervisor 499, client device 490), or a combination thereof. System 400 includes a query broadcast module 410. Query broadcast module 410 may receive a query from a supervisor 499. Query broadcast module may also broadcast the query to a set of client device 490. The query may request a graphical response from users of members of the set of client devices. System 400 also includes a response collection module 420. Response collection module may receive graphical responses to the query from client device 490.

System 400 also includes a clustering module 430. Clustering module 430 may organize the graphical responses into a set of groups based on graphical attributes of the graphical responses. In some examples, clustering module 430 may organize graphical responses into groups by representing the graphical responses as feature vectors and clustering the graphical responses according to the feature vectors. In other examples, clustering module 430 may compare graphical attributes of graphical responses to a set of expected results to organize the graphical responses into the groups.

System 400 also includes a sample delivery module 440. Sample delivery module may provide representative samples of members of the set of groups to supervisor 499. In one example, sample delivery module may be able to provide representative samples to, for example, a public display, client devices 490, and so forth. The provision of representative samples to the public display or client devices 490 may be controlled by a signal received from supervisor 499. This may allow supervisor 499 to lead a discussion related to the representative samples.

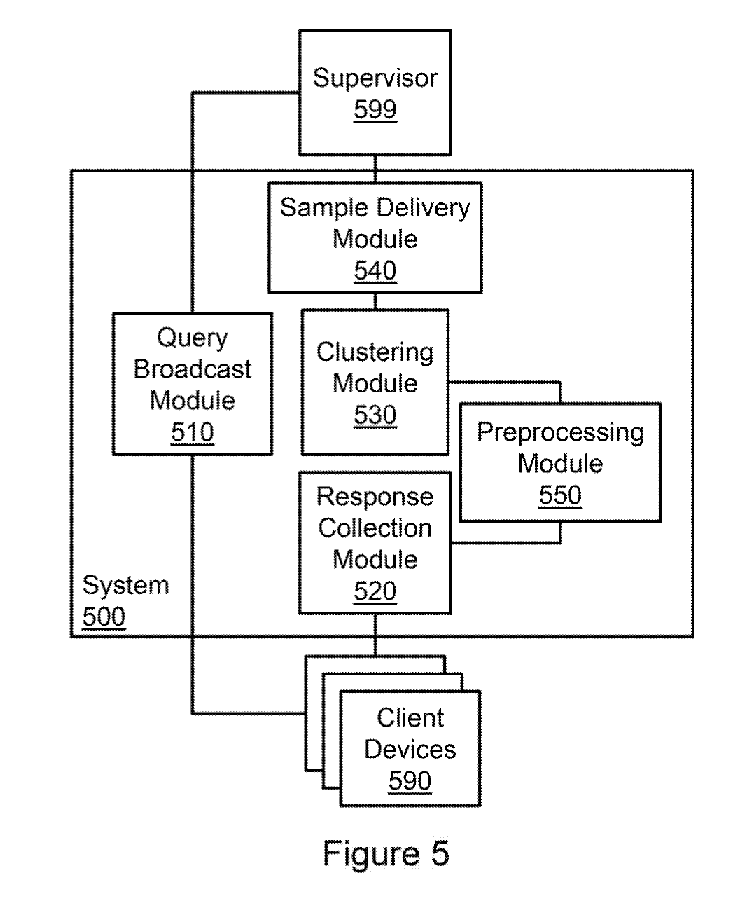

FIG. 5 illustrates a system 500 associated with graphical response grouping. System 500 includes several items similar to those described above with reference to system 400 (FIG. 4). For example, system 500 includes a query broadcast module 510, a response collection module 520, a clustering module 530, and a sample deliver module 540. Further, various components of system 500 may communicate with a supervisor 599 and/or a set of client devices 590.

System 500 also includes a preprocessing module 550. Preprocessing module may perform various functions on graphical responses collected by response collection module 520 from client device 590 prior to clustering module 530 organizing the graphical responses into groups. For example, preprocessing module 550 may subtract template information from the graphical responses, amongst other functionality.

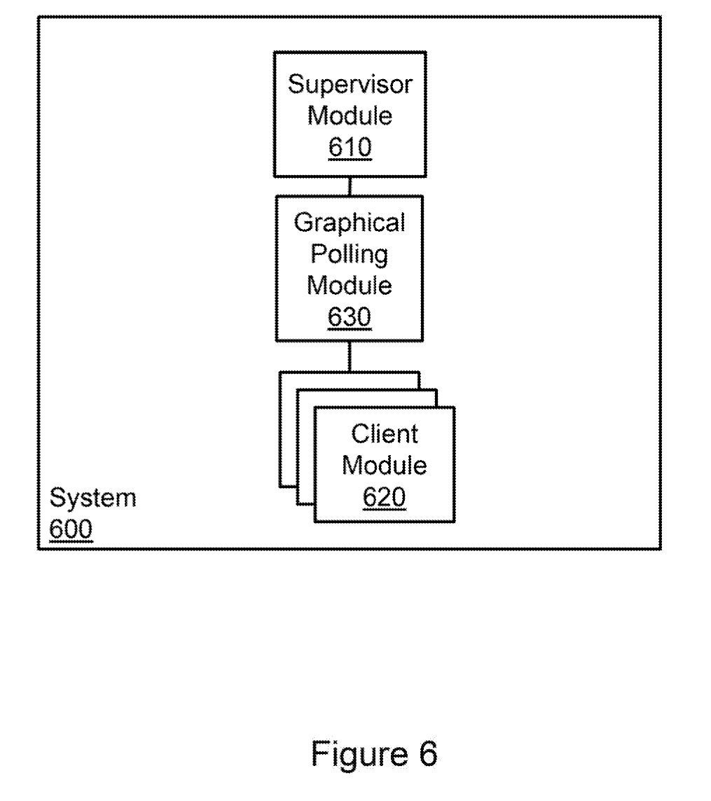

FIG. 6 illustrates a system 600 associated with graphical response grouping. System 600 includes a supervisor module 610. Supervisor module 610 may be operated by a supervisor (e.g., teacher). Supervisor module 610 may be operated by the supervisor on a device controlled by the supervisor (e.g., desktop, laptop, tablet, mobile device). In various examples, the supervisor may be a teacher, instructor, or other form of discussion leader.

System 600 also includes a set of client modules 620. Client modules 620 may be operated by respective users. Client modules 620 may be operated on devices (e.g., desktop, laptop, tablet, mobile device) controlled by these users.

System 600 also includes a graphical polling module 630. Graphical polling module 630 may forward a query requesting a graphical response from supervisor module 610 to members of the set of client modules 620. Graphical polling module may also duster graphical responses to the query into groups. The graphical responses may be received from members of the set of client modules 620. Graphical polling module may also provide representative samples of the groups to supervisor module 610. In some examples, graphical polling modules 630 may ignore common information in the graphical responses when clustering the graphical responses.

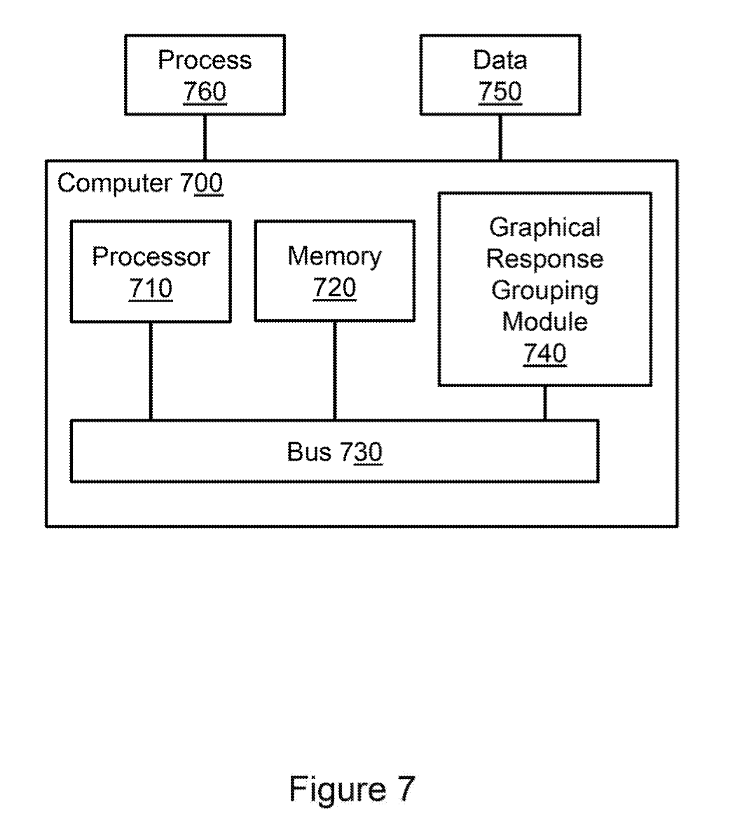

FIG. 7 illustrates an example computer in which example systems and methods, and equivalents, may operate. The example computer may include components such as a processor 710 and a memory 720 connected by a bus 730. Computer 700 also includes a graphical response grouping module 740. Graphical response grouping module 740 may perform, alone or in combination, various functions described above with reference to the example systems, methods, apparatuses, and so forth. In different examples, Graphical response grouping module 740 may be implemented as a non-transitory computer-readable medium storing processor-executable instructions, in hardware, software, firmware, an application specific integrated circuit, and/or combinations thereof.

The instructions may also be presented to computer 700 as data 750 and/or process 760 that are temporarily stored in memory 720 and then executed by processor 710. The processor 710 may be a variety of processors including dual microprocessor and other multi-processor architectures. Memory 720 may include non-volatile memory (e.g., read only memory) and/or volatile memory (e.g., random access memory). Memory 720 may also be, for example, a magnetic disk drive, a solid state disk drive, a floppy disk drive, a tape drive, a flash memory card, an optical disk, and so on. Thus, memory 720 may store process 760 and/or data 750. Computer 700 may also be associated with other devices including computers, printers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
providing a query to a set of client devices, the query requesting a graphical response from respective users of members of the set of client devices;
receiving graphical responses from the respective users via the client devices;
classifying the graphical responses into groups, based on graphical attributes of the graphical responses; and
providing representative responses from the groups to a supervisor.

2. The method of claim 1, comprising receiving the query from the supervisor.

3. The method of claim 1, where the query comprises a template, where the graphical responses are provided on top of the template, and where the method comprises subtracting the template from the graphical responses.

4. The method of claim 1, comprising publically sharing a representative response in response to an instruction from the supervisor.

5. The method of claim 1, where classifying the graphical responses includes representing the graphical responses as feature vectors, and clustering the graphical responses according to the feature vectors.

6. The method of claim 5, where a representative response is provided from a group when a feature vector associated with that representative response is closest to a center of a duster of feature vectors associated with the group.

7. The method of claim 5, where an attribute of a graphical response is emphasized by assigning greater weight to a dimension of feature vectors associated with that attribute when clustering the graphical responses.

8. The method of claim 1, comprising providing outlier responses to the supervisor.

9. A system, comprising:
a query broadcast module to receive a query from a supervisor and to broadcast the query to a set of client devices, the query requesting a graphical response from users of members of the set of client devices;
a response collection module to receive graphical responses to the query from the client devices;
a clustering module to organize the graphical responses into a set of groups based on graphical attributes of the graphical responses; and
a sample delivery module to provide representative samples of members of the set of groups to the supervisor.

10. The system of claim 9, where the sample delivery module, in response to a signal from the supervisor, provides a representative sample to at least one of a public display and a client device.

11. The system of claim 9, comprising a preprocessing module to subtract template information from the graphical responses.

12. The system of claim 9, where the clustering module organizes the graphical responses into groups by representing the graphical responses as feature vectors, and clustering the graphical responses according to the feature vectors

13. The system of claim 9, where the clustering module organizes the graphical responses by comparing graphical attributes of the graphical responses to one another.

14. A system, comprising:
a supervisor module to be operated by a supervisor;
a set of client modules to be operated by respective users; and
a graphical polling module to forward a query requesting a graphical response from the supervisor module to members of the set of client modules, to cluster graphical responses to the query received from the members of the set of client modules into groups, and to provide representative samples of the groups to the supervisor module.

15. The system of claim 14, where the graphical polling module ignores common information in the graphical responses when clustering the graphical responses.
